(19) United States
(12) Patent Application Publication
(10) Pub. No.: US 2021/0394473 A1
(43) Pub. Date: Dec. 23, 2021

(54) METHOD AND DEVICE FOR MANUFACTURING VIEWING ANGLE-RESTRICTING FILM

(71) Applicant: Jeong Ki CHO, Daejeon (KR)

(72) Inventor: Jeong Ki CHO, Daejeon (KR)

(21) Appl. No.: 17/360,038

(22) Filed: Jun. 28, 2021

Related U.S. Application Data
(63) Continuation of application No. PCT/KR2019/017015, filed on Dec. 4, 2019.

(30) Foreign Application Priority Data
Dec. 31, 2018 (KR) 10-2018-0174037

(51) Int. Cl. B29D 11/00; G02B 1/04; G02B 5/20; B23K 26/00; B23K 26/38

(52) U.S. Cl. CPC B29D 11/00788; G02B 1/04; B29D 11/00932; B23K 26/0093; B23K 26/38; G02B 5/20

(57) ABSTRACT

A method for manufacturing a viewing angle-restricting film includes arranging a light-transmitting resin layer on a first inclined surface, wherein the light-transmitting layer is one of a liquid light-transmitting resin layer and a solid light-transmitting resin layer, forming a plurality of parallel first slits in the light-transmitting resin layer using one of a plurality of blades arranged parallel to each other and a plurality of lasers arranged parallel to each other, and filling the plurality of first slits with a light non-transmitting material to form a viewing angle-restricting film including the light-transmitting resin layer and the light non-transmitting material.

### CROSS-REFERENCE TO RELATED APPLICATIONS

The present application is a continuation application of International Application No. PCT/KR2019/017015, filed Dec. 4, 2019, which claims the benefit of and priority to Korean Application No. 10-2018-0174037, filed Dec. 31, 2018. The above-referenced applications are hereby incorporated herein by reference in their entirety.

### FIELD

The present disclosure relates to a method and apparatus for manufacturing a viewing angle-restricting film. Specifically, the present disclosure relates to a method and apparatus for efficiently manufacturing a viewing angle-restricting film using an inclined surface, and the present disclosure relates to a viewing angle-restricting film manufactured by the method.

### BACKGROUND

The statements in this section merely provide background information related to the present disclosure and may not constitute prior art.

A viewing angle-restricting film is formed by alternately arranging an opaque member blocking light and a transparent member. The transparent member allows light to be transmitted through a front surface of a display or a window so that an object displayed on a display or through the window can be seen, and the opaque member blocks light on a side surface of the display or window so that the object displayed on a display or through the window cannot be seen.

The conventional viewing angle-restricting film has a structure in which opaque members are arranged in a direction perpendicular to a film. Therefore, light passing through the conventional viewing angle-restricting film is directed only to the front and not to the side. The conventional viewing angle-restricting film has an effect that a person located on the side surface of the display or window cannot see an object displayed through the display or window. However, the conventional viewing angle-restricting film has a problem in that an edge of the display or window looks dark from the point of view of an operator, and rather than the operator, a person behind the operator sees the edge more clearly.

A new structure is known which supplements the conventional viewing angle-restricting film. According to the known structure of U.S. Pat. No. 3,919,559, an extension line of an opaque member should be directed to a predetermined region so that light is collected in a region close to a front surface of a display or window and light is not collected in a region farther from a side surface and the front surface of the display or window. Accordingly, the closer to the side surface from the center of the display or window, the more an angle of the opaque member is inclined.

According to Korean Patent Laid-Open No. 10-2011-0087886, to manufacture a viewing angle-restricting film having a new structure, after alternately stacking a transparent member and an opaque member, the viewing angle-restricting film is manufactured by heat-compressing the stacked transparent member and opaque member non-uniformly and vertically cutting the heat-compressed transparent member and opaque member. However, this conventional method has complicated procedures such as lamination, compression, and cutting which increases costs and is inefficient in terms of the operation.

Therefore, there is a need for a method and apparatus for manufacturing a viewing angle-restricting film in an efficient manner so that the opaque member faces a predetermined region.

### SUMMARY

This section provides a general summary of the disclosure and is not a comprehensive disclosure of its full scope or all of its features.

One aspect of the present disclosure provides a method of manufacturing a viewing angle-restricting film, the method including arranging a liquid or solid light-transmitting resin layer on a first inclined surface and forming a plurality of parallel first slits in the light-transmitting resin layer, in which a depth direction of each of the first slits is perpendicular to a tangent line of a highest point of the first inclined surface, and a length direction of each of the first slits is perpendicular to the first inclined surface.

Another aspect of the present disclosure provides an apparatus for manufacturing a viewing angle-restricting film, the apparatus including a first inclined surface on which a liquid or solid light-transmitting resin layer, and a first slit forming part in which a plurality of parallel first slits are formed in the light-transmitting resin layer, in which a depth direction of each of the first slits is perpendicular to a tangent line of a highest point of the first inclined surface, and a length direction of each of the first slits is perpendicular to the first inclined surface.

Still another aspect of the present disclosure provides a viewing angle-restricting film manufactured according to the method of manufacturing of a viewing angle-restricting film.

In one aspect, the relay apparatus may be a smart repeater.

### DRAWINGS

FIG. 1A illustrates a perspective view of a viewing angle-restricting film according to various embodiments of the present disclosure.

FIG. 1B illustrates a cross-sectional view of a viewing angle-restricting film according to various embodiments of the present disclosure.

FIG. 2 illustrates a flowchart of a method for manufacturing a viewing angle-restricting film according to various embodiments of the present disclosure.

FIG. 3A illustrates a block diagram of an apparatus for manufacturing a viewing angle-restricting film according to various embodiments of the present disclosure.

FIG. 3B is a perspective view illustrating an inclined surface of the viewing angle-restricting film according to various embodiments of the present disclosure.

FIG. 4A illustrates a manufacturing process of the viewing angle-restricting film according to various embodiments of the present disclosure.

FIG. 4B illustrates a manufacturing process of the viewing angle-restricting film according to various embodiments of the present disclosure.

FIG. 4C illustrates another example of a slit forming part according to various embodiments of the present disclosure.

FIG. 5A illustrates an operation of forming slits of the viewing angle-restricting film according to various embodiments of the present disclosure.

FIG. 5B illustrates an operation of forming slits of the viewing angle-restricting film according to various embodiments of the present disclosure.

FIG. 6A illustrates an operation of deriving an inclined surface having a curved shape according to various embodiments of the present disclosure.

FIG. 6B illustrates an operation of deriving an inclined surface having a curved shape according to various embodiments of the present disclosure.

FIG. 6C illustrates an operation of deriving an inclined surface having a curved shape according to various embodiments of the present disclosure.

FIG. 6D illustrates an operation of deriving an inclined surface having a curved shape according to various embodiments of the present disclosure.

FIG. 6E illustrates an operation of deriving an inclined surface having a curved shape according to various embodiments of the present disclosure.

FIG. 6F illustrates an operation of deriving an inclined surface having a curved shape according to various embodiments of the present disclosure.

FIG. 6G illustrates an operation of deriving an inclined surface having a curved shape according to various embodiments of the present disclosure.

FIG. 7A illustrates an operation of deriving an inclined surface having a polygonal shape according to various embodiments of the present disclosure.

FIG. 7B illustrates an operation of deriving an inclined surface having a polygonal shape according to various embodiments of the present disclosure.

FIG. 8 illustrates a viewing angle-restricting film in which first slits and second slits are formed according to various embodiments of the present disclosure.

### DETAILED DESCRIPTION

The present disclosure has the following objects to solve the above-described problems.

The present disclosure is directed to a method and apparatus for manufacturing a viewing angle-restricting film so that an opaque member faces a predetermined region.

The present disclosure is directed to providing a viewing angle-restricting film manufactured by the method.

The object of the present disclosure is not limited to those mentioned above, and other objects not mentioned above will be clearly understood by those of ordinary skill in the art from the description below.

Hereinafter, with reference to the accompanying drawings, embodiments of the present disclosure will be described in detail. The present disclosure may be implemented in several different forms and is not limited to the embodiments described herein.

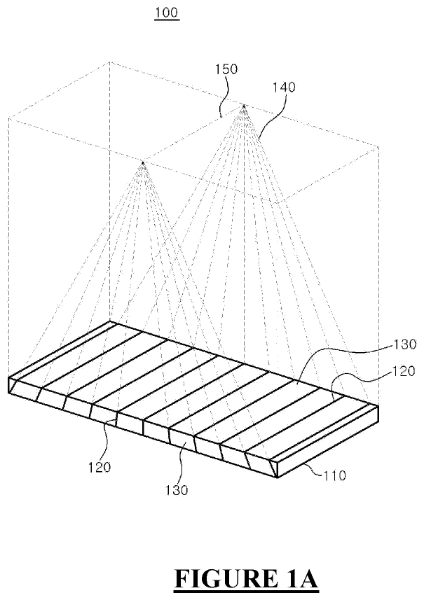

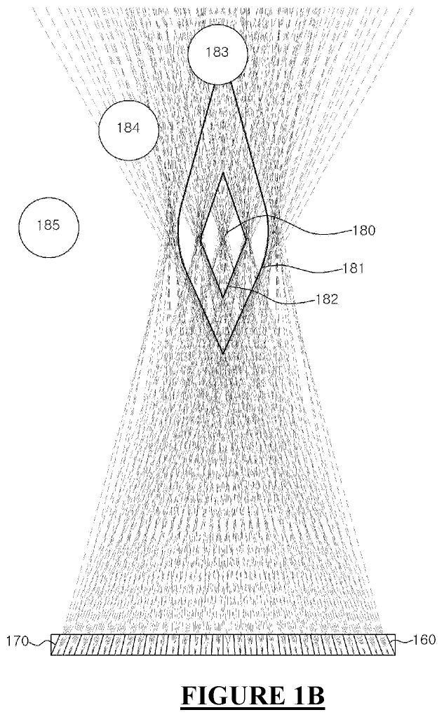

FIG. 1A illustrates a perspective view of a viewing angle-restricting film according to various embodiments of the present disclosure.

Referring to FIG. 1A, a viewing angle-restricting film 100 according to various embodiments of the present disclosure includes a light-transmitting film 110, an opaque portion 120, and a transparent portion 130.

The light-transmitting film 110 is a film through which light can be transmitted, and the light-transmitting film 110 may be cut and provided in various sizes to cover display devices or windows of various sizes.

A plurality of opaque portions 120 may be spaced apart from each other by a predetermined distance in a lateral direction of the light-transmitting film 110. The transparent portion 130 may be formed by dividing the light-transmitting film 110 using a plurality of opaque portions 120.

Extension lines 140 of the opaque portions 120 are connected by a virtual central vertical line 150. That is, by passing light toward a periphery of the virtual central vertical line 150, it is possible to block a viewing angle of people located at places other than a viewing angle of a user located on the virtual central vertical line 150.

In one embodiment, the places other than the viewing angle of the user includes a left or right side with respect to the virtual central vertical line 150 and a front surface located further away from the viewing angle-restricting film 100 than the virtual central vertical line 150. That is, even when a person other than a user who uses the display device is positioned in front of the display device, the person cannot clearly observe a screen displayed on the display device. As such, security is substantially improved when maintaining an appropriate distance between the user and the display device.

FIG. 1B illustrates a cross-sectional view of a viewing angle-restricting film according to various embodiments of the present disclosure.

Specifically, FIG. 1B illustrates a cross-sectional view of the viewing angle-restricting film 100 of FIG. 1A.

Referring to FIG. 1B, a viewing angle-restricting film 160 includes a plurality of opaque portions 170, and extension lines of the plurality of opaque portions 170 are focused at a predetermined focal point 180. That is, light emitted through the transparent portions between the plurality of opaque portions 170 in the viewing angle-restricting film 160 travels straight at an angle equal to a viewing angle limiting effect and is focused at the predetermined focal point 180.

Each of the plurality of opaque portions 170 blocks a significant portion of light directed in directions other than light directed to a work region 182 of the user around the predetermined focal point 180, and thus, the viewing angle of a person located at another place 185 may be blocked. In addition, even in the front of the viewing angle-restricting film 160, a person located at other places 183 and 184 cannot clearly see an object displayed through the attached display or a window, and the object may appear blurry. The object displayed through the display or window to which the viewing angle-restricting film 160 is attached may be seen in a visible region 181 around the predetermined focal point 180 and may be seen relatively clearly within a work region 182 of the user.

The plurality of opaque portions 170 have a structure in which the closer to a side surface starting from a central portion of the viewing angle-restricting film 160, the more an inclined angle increases.

To manufacture a viewing angle-restricting film of the structure, in the prior art, a transparent member and an opaque member were alternately stacked and then heat-compressed unevenly and cut vertically. However, this conventional method includes complicated procedures, such as stacking, non-uniform pressing and cutting, which increases costs and is inefficient in terms of the operation.

Therefore, there is a need for a method and apparatus for manufacturing a viewing angle-restricting film so that the opaque member faces a predetermined region.

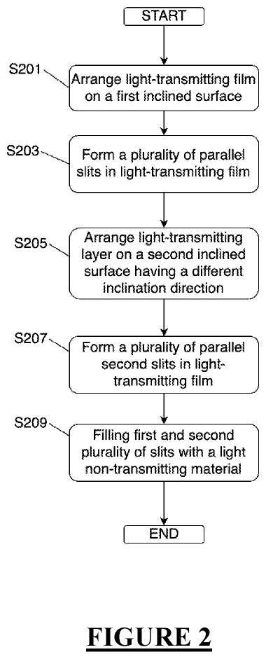

FIG. 2 illustrates a flowchart of a method for manufacturing a viewing angle-restricting film according to various embodiments of the present disclosure.

Referring to FIG. 2, in operation S201, a liquid or solid light-transmitting resin layer is disposed on a first inclined surface. Here, in the light-transmitting resin layer, a polymer, a thermoplastic resin, a thermosetting resin, a resin curable by actinic rays (e.g., ultra-violet (UV) light), or the like may be used. Examples resins include cellulose resins (e.g., cellulose acetate butyrate (CAB) and triacetyl cellulose (TAC)), polyolefin resins (e.g., polyethylene and polypropylene), polyester resins (e.g., polyethylene terephthalate (PET), polystyrene, polyurethane, polyvinyl chloride (PVC), acrylic resins, polycarbonate resins), or the like. A liquid or a solid light-transmitting resin layer may constitute a light-transmitting film. The liquid light-transmitting resin layer is a thin film made of a light-transmitting resin in a liquid state, and a light-transmitting film is formed by solidifying the liquid light-transmitting resin layer. The solid light-transmitting resin layer is a thin film made of a light-transmitting resin and can constitute a light-transmitting film by itself.

In operation S203, a plurality of parallel first slits are formed in the light-transmitting resin layer. A depth direction of the first slits is perpendicular to a tangent line of the highest point of the first inclined surface, and a length direction of the first slits is perpendicular to an inclination direction of the first inclined surface. When the viewing angle-restricting film manufactured by operations S201 and S203 is disposed on a plane, extension lines of the plurality of first slits may be directed toward one common region. According to an embodiment, the one common region is one common focal point. According to another exemplary embodiment, the one common region is one region within a predetermined range around the one common focal point.

According to various embodiments of the present disclosure, a plurality of first slits is formed using a plurality of blades arranged parallel to each other or a plurality of lasers arranged parallel to each other. According to an embodiment, the plurality of first slits may be formed by a mold including a plurality of blades arranged parallel to each other. According to various embodiments, the mold including the plurality of parallel blades may be a mold suitable for covering the first inclined surface corresponding to the overall shape of the first inclined surface, a rotation type rolled-shaped mold corresponding to a curved shape of the first inclined surface, or a slide-type mold corresponding to the curved shape of the first inclined surface. According to various embodiments, various molding steps (e.g., heat and pressure) may be performed on either the inside or the outside of the first inclined surface. According to various embodiments, the molding includes any one of injection molding, compression molding, transfer molding, cast molding, pressure molding, pressure heating molding, or pattern molding.

According to various embodiments of the present disclosure, the first inclined surface has a curved shape.

According to various embodiments of the present disclosure, the first inclined surface is based on the curve of the following [Equation 1].

$$y = - 2 r \cdot {sinh}^{2} ( \frac{x}{2 r} ) \qquad [ Equation 1 ]$$

In [Equation 1], x denotes a coordinate on a horizontal axis with a center of the first inclined surface as an origin, y denotes a coordinate on a vertical axis with the center of the first inclined surface as the origin, and r denotes a distance from the center of the first inclined surface to the one common region toward which the extension lines of the plurality of parallel first slits are directed when the viewing angle-restricting film is disposed on a plane.

According to an embodiment, a cross section of the first inclined surface has a curved shape that matches the curve of [Equation 1]. According to another embodiment, the cross section of the first inclined surface is the form of a curve having the curve of [Equation 1] and a difference within a predetermined range on the y-axis and within a predetermined range on the x-axis. According to an embodiment, the cross section of the first inclined surface has a shape that is one of a circle, an ellipse, a parabola, and a hyperbola, and the cross section of the first inclined surface has the curve of [Equation 1] and the difference within the predetermined range on the y-axis and within the predetermined range on the x-axis. According to an embodiment, the predetermined range on the x-axis is a range of ±50% of the distance r based on the origin, and the predetermined range on the y-axis is a range of ±20% of the distance r.

According to another embodiment, the cross section of the first inclined surface has a polygonal shape including a predetermined number of tangent lines with respect to the curve of [Equation 1]. In one embodiment, lengths of sides of the polygon may be equal to each other.

According to various embodiments of the present disclosure, after operations S201 and S203, the method of manufacturing the viewing angle-restricting film may further include arranging the light-transmitting resin layer on a second inclined surface having an inclination direction that is different than an inclination direction of the first inclined surface as operation S205. The method of manufacturing the viewing angle-restricting film may further include forming a plurality of parallel second slits in the light-transmitting resin layer as operation S207, in which a depth direction of the second slits may be perpendicular to a tangent line of the highest point of the second inclined surface, and a length direction of the second slits may be perpendicular to the inclination direction of the second inclined surface. Accordingly, security is realized by restricting the viewing angle not only in one direction, but also in a plurality of directions with respect to the display or window to which the viewing angle-restricting film is attached. According to an embodiment, when the viewing angle-restricting film is disposed on a plane, the extension lines of the plurality of first slits and the extension lines of the plurality of second slits are directed toward the one common region. According to an embodiment, the one common region is one common focal point. According to another exemplary embodiment, the one common region is one region within a predetermined range based on one common focal point. According to an embodiment, the inclination direction of the first inclined surface and the inclination direction of the second inclined surface are perpendicular to each other.

According to various embodiments of the present disclosure, after operation S203 or operation S207, the manufacturing method of the viewing angle-restricting film may further include, as operation S209, filling the plurality of first slits and the plurality of second slits with a light non-transmitting material. In one embodiment, a material used as the light non-transmitting material may include one or more of a dark color pigment or a dark color dye (e.g., a black or gray pigment or dye), a metal (e.g., aluminum and silver), dark colored metal oxides, dark colored opaque adhesive ink, and a material that is transparent during filling but is changed opaquely when cured by actinic rays, such as ultraviolet (UV) rays.

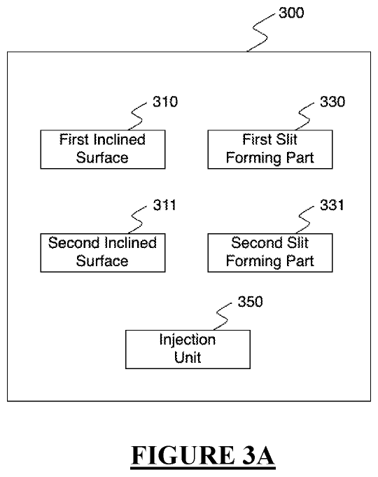

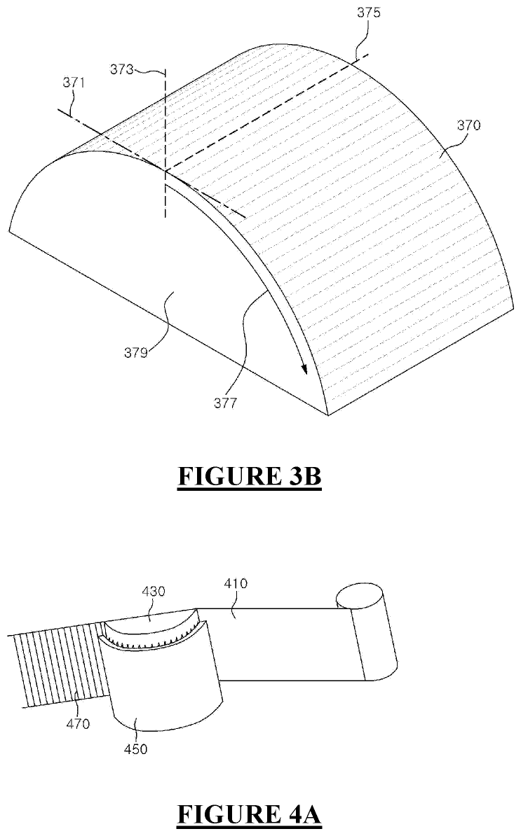

FIG. 3A illustrates a block diagram of an apparatus for manufacturing a viewing angle-restricting film according to various embodiments of the present disclosure.

Referring to FIG. 3A, an apparatus 300 for manufacturing a viewing angle-restricting film according to various embodiments of the present disclosure includes a first inclined surface 310 and a first slit forming part 330.

A light-transmitting resin layer is disposed on the first inclined surface 310. In one embodiment, as the light-transmitting resin layer, a thermoplastic resin, a thermosetting resin, a resin curable by actinic rays such as UV light, or the like may be used as a polymer. Examples of the resins may include cellulose resins such as CAB and TAC, polyolefin resins such as polyethylene and polypropylene, polyester resins such as PET, polystyrene, polyurethane, or PVC, acrylic resins, polycarbonate resins, or the like. A liquid or solid light-transmitting resin layer may constitute the light-transmitting film. The liquid light-transmitting resin layer is a thin film made of a light-transmitting resin in a liquid state, and a light-transmitting film is formed by solidifying the liquid light-transmitting resin layer. The solid light-transmitting resin layer is a thin film made of a light-transmitting resin and can constitute a light-transmitting film by itself.

According to various embodiments of the present disclosure, the first inclined surface 310 has a curved shape.

According to various embodiments of the present disclosure, a cross section of the first inclined surface 310 is based on the curve of [Equation 1].

According to one embodiment, the cross section of the first inclined surface 310 has a curved shape that matches the curve of [Equation 1]. According to another embodiment, the cross section of the first inclined surface 310 is in the form of a curve having the curve of [Equation 1] and a difference within a predetermined range on the y-axis and within a predetermined range on the x-axis. According to an embodiment, the cross section of the first inclined surface 310 is formed as one of a circle, an ellipse, a parabola, and a hyperbola having the curve of [Equation 1] and the difference within the predetermined range on the y-axis and within the predetermined range on the x-axis. According to an embodiment, the predetermined range on the x-axis is a range of ±50% of the distance r based on the origin, and the predetermined range on the y-axis is a range of ±20% of the distance r.

According to another embodiment, the cross section of the first inclined surface 310 has a polygonal shape including a predetermined number of tangent lines with respect to the curve of [Equation 1]. In one embodiment, the lengths of the sides of the polygon may be equal to each other.

The first slit forming part 330 forms first slits parallel to the light-transmitting resin layer. The depth direction of the first slits is perpendicular to the tangent line of the highest point of the first inclined surface, and the length direction of the first slits is perpendicular to the inclination direction of the first inclined surface. When the viewing angle-restricting film is disposed on a plane, the extension lines of the plurality of first slits may be directed toward one common region. According to an embodiment, the one common region is one common focal point. According to another exemplary embodiment, the one common region is one region within a predetermined range based on one common focal point.

According to various embodiments of the present disclosure, the first slit forming part 330 includes a plurality of blades arranged parallel to each other or a plurality of laser devices arranged parallel to each other. Accordingly, the plurality of first slits is formed using the plurality of parallel blades or the plurality of lasers of the first slit forming part 330. According to an embodiment, the first slit forming part 330 may include a mold including a plurality of blades arranged parallel to each other. According to an embodiment, the plurality of first slits may be formed by transferring and molding a pattern using a mold suitable for covering the first inclined surface corresponding to the overall shape of the first inclined surface including the plurality of blades arranged parallel to each other, a rotation type rolled-shaped mold corresponding to the curved shape of the first inclined surface, or a slide-type mold corresponding to the curved shape of the first inclined surface. In one embodiment, the molding may be performed on either the inside or the outside of the first inclined surface. In one embodiment, the molding includes any one of injection molding, compression molding, transfer molding, cast molding, pressure molding, pressure heating molding, or pattern molding.

In this disclosure, the description of a blade may be similarly applied to a laser.

The apparatus 300 for manufacturing a viewing angle-restricting film according to various embodiments of the present disclosure may further include a second inclined surface 311 and a second slit forming part 331.

The second inclined surface 311 has the inclination direction different than an incline direction of the first inclined surface 310, and a light-transmitting resin layer is disposed thereon. According to an embodiment, the inclination direction of the first inclined surface 310 and the inclination direction of the second inclined surface 311 are perpendicular to each other.

The second slit forming part 331 forms a plurality of parallel second slits in the light-transmitting resin layer. A depth direction of the second slits is perpendicular to a tangent line of a highest point of the second inclined surface, and a length direction of the second slits is perpendicular to the inclination direction of the second inclined surface. When the viewing angle-restricting film is disposed on a plane, the extension lines of the plurality of first slits are directed toward the one common region. Accordingly, the length direction of the first slits and the length direction of the second slits are perpendicular to each other.

The depth direction of the second slits may be perpendicular to the tangent line of the highest point of the second inclined surface, and the length direction of the second slits may be perpendicular to the inclination direction of the second inclined surface. Accordingly, security is realized by restricting the viewing angle not only in one direction, but also in a plurality of directions with respect to the display or window to which the viewing angle-restricting film is attached. According to one embodiment, when the viewing angle-restricting film is disposed on a plane, the extension lines of the plurality of first slits and the extension lines of the plurality of second slits are directed toward the one common region. According to an embodiment, the one common region is one common focal point. According to another exemplary embodiment, the one common region is one region within a predetermined range based on one common focal point.

The apparatus 300 for manufacturing a viewing angle-restricting film according to various embodiments of the present disclosure may further include an injection unit 350.

A light non-transmitting material fills the plurality of first slits and the plurality of second slits through the injection unit 350. In one embodiment, a material used as the light non-transmitting material may include one or more of a dark color pigment or a dark color dye (e.g., a black or gray pigment or dye), a metal (e.g., aluminum and silver), a dark colored metal oxide, dark colored opaque adhesive ink, a material that is transparent in a filling state but changes to being opaque when cured by actinic rays, such as UV rays.

FIG. 3B is a perspective view illustrating an inclined surface of the viewing angle-restricting film according to various embodiments of the present disclosure.

Referring to FIG. 3B, a tangent line 371 of a highest point of an inclined surface 370 may be parallel to the plane. A depth direction of slits formed in a film made of a light-transmitting resin layer on the inclined surface 370 is a direction 373 perpendicular to the tangent line 371 of the highest point of the inclined surface 370.

The inclined surface 370 may have a shape facing a length direction 375 of the inclined surface. The length direction 375 of the inclined surface is perpendicular to an inclination direction 377.

The length direction of the slits formed in the film made of the light-transmitting resin layer on the inclined surface 370 is perpendicular to the inclination direction 377 of the inclined surface 370.

A cross section 379 of the inclined surface 370 may have a curved shape or a polygonal shape. The cross section 379 of the inclined surface 370 is perpendicular to the length direction 375 of the inclined surface.

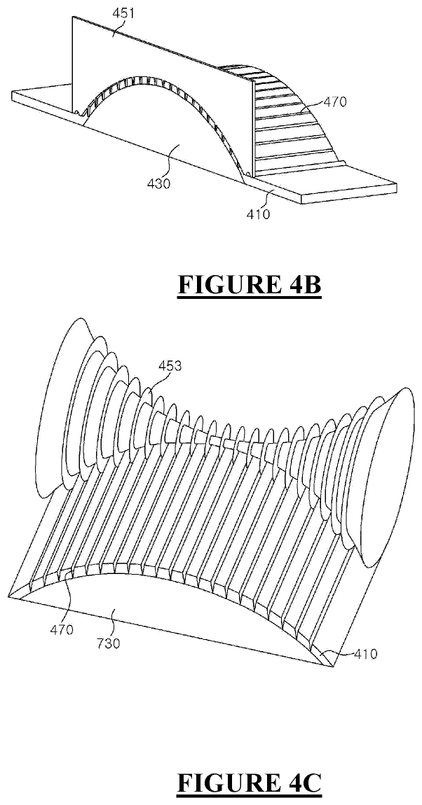

FIGS. 4A to 4C illustrate a manufacturing process of the viewing angle-restricting film according to various embodiments of the present disclosure.

Referring to FIG. 4A, a light-transmitting resin layer 410 unwound from a roll is disposed on an inclined surface pedestal 430 having a curved shape, and then, a plurality of parallel slits 470 are formed using a slit forming part 450 including a plurality of blades arranged parallel to each other. The plurality of parallel slits 470 may be formed by press-molding the slit forming part 450 with respect to the light-transmitting resin layer 410 in the depth direction of the slits 470. The depth direction of the plurality of parallel slits 470 is perpendicular to the tangent line of the highest point of the inclined surface of the pedestal 430, and the length direction of the plurality of parallel slits 470 is perpendicular to the inclination direction of the inclined surface of the pedestal 430. The formed plurality of parallel slits 470 are filled with light non-transmitting materials.

Referring to FIG. 4B, by sliding a slit forming part 451 including a plurality of blades arranged parallel to each other with respect to the light transmitting resin layer 410 disposed on the inclined surface pedestal 430 having a curved shape, the plurality of parallel slits 470 may be formed in the light-transmitting resin layer 410. The depth direction of the plurality of parallel slits 470 is perpendicular to the tangent line of the highest point of the inclined surface of the pedestal 430, and the length direction of the plurality of parallel slits 470 is perpendicular to the inclination direction of the inclined surface of the pedestal 430.

Referring to FIG. 4C, by rotating a slit forming part 453 including the plurality of blades arranged parallel to each other with respect to the light-transmitting resin layer 410 disposed on the inclined surface pedestal 430 having a curved shape, the plurality of parallel slits 470 may be formed in the light-transmitting resin layer 410.

The depth direction of the plurality of parallel slits 470 is perpendicular to the tangent line of the highest point of the inclined surface of the pedestal 430, and the length direction of the plurality of parallel slits 470 is perpendicular to the inclination direction of the inclined surface of the pedestal 430.

Therefore, while the slit forming part 450 of FIG. 4A vertically presses the light-transmitting resin layer to form the plurality of linear slits, the slit forming part 451 of FIG. 4B slides the blades to form the plurality of linear slits, and the slit forming part 453 of FIG. 4C moves while rotating so that the plurality of annular blades form a plurality of linear slits identical to the slit forming parts 450 and 451 of FIGS. 4A and 4B, respectively.

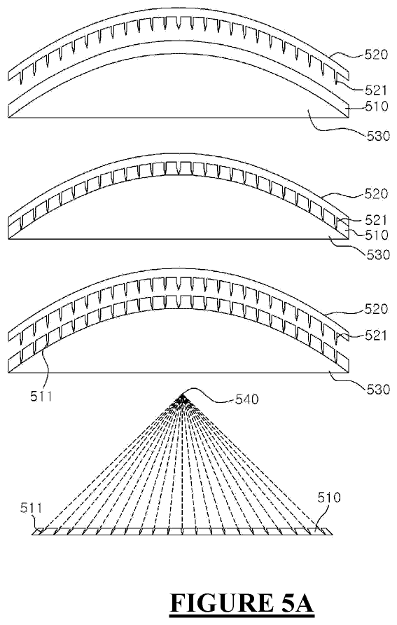

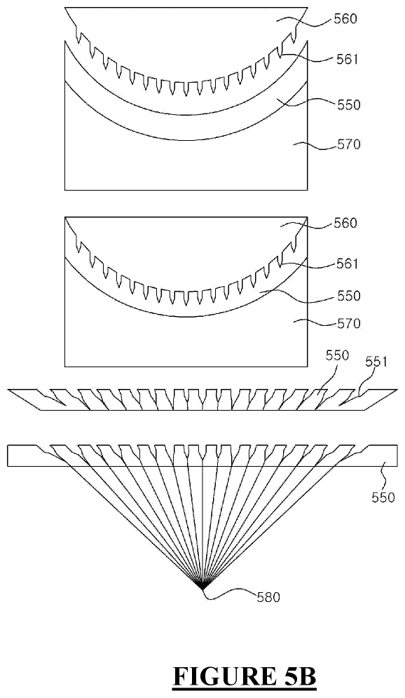

FIGS. 5A and 5B illustrate an operation of forming slits of a viewing angle-restricting film according to various embodiments of the present disclosure.

Referring to FIG. 5A, a light-transmitting resin layer 510 is disposed on an inclined surface 530. The light-transmitting resin layer 510 is disposed to have the same shape as the inclined shape of the inclined surface 530. Although the cross section of the inclined surface 530 in FIG. 5A has a curved shape, it is not limited to the curved shape and may have a polygonal shape as will be described below with reference to FIGS. 7A and 7B.

Referring to FIG. 5A, a slit forming part 520 including a plurality of parallel blades 521 forms a plurality of slits 511 in the light-transmitting resin layer 510. The plurality of parallel blades 521 and the plurality of slits 511 formed by the blades 521 are parallel to a vertical axis having a center of the inclined surface 530 as an origin.

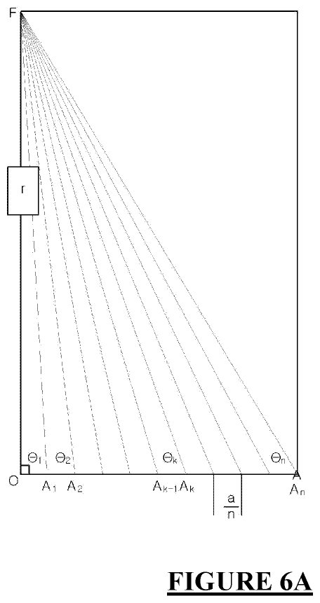

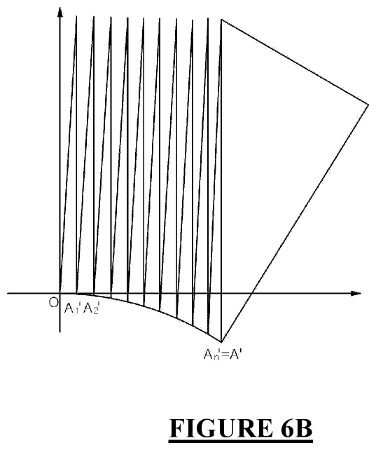

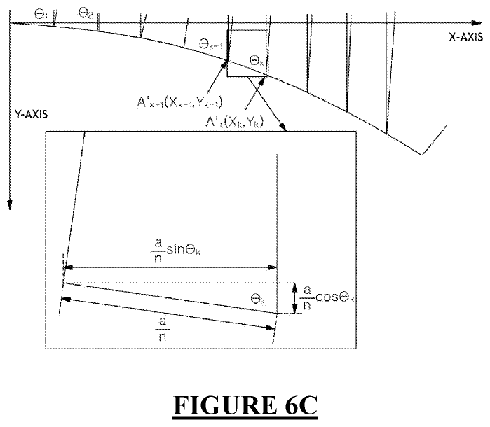

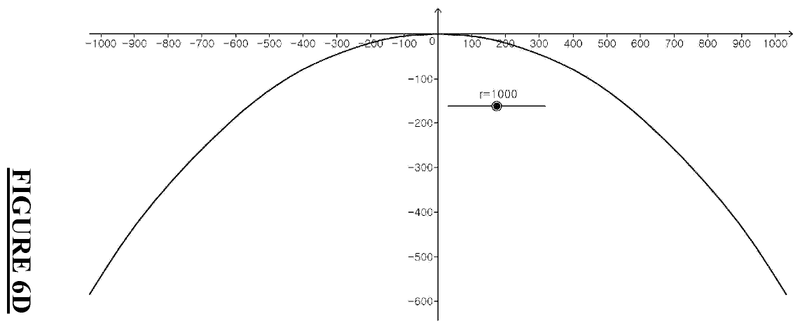

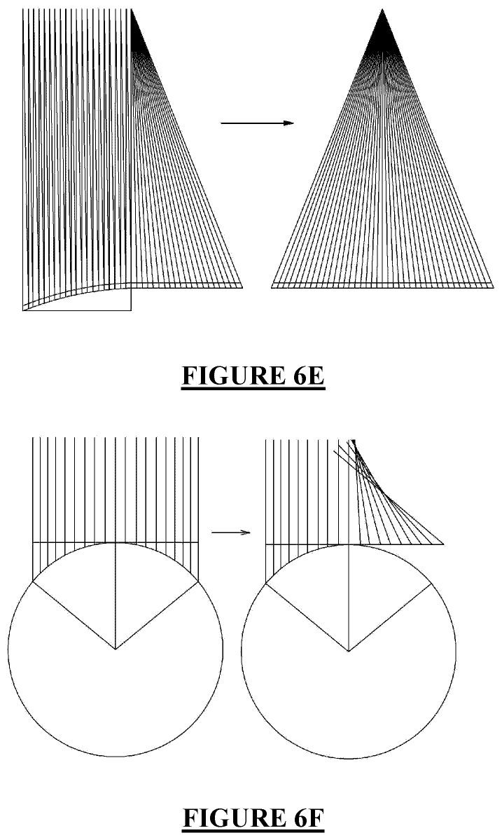

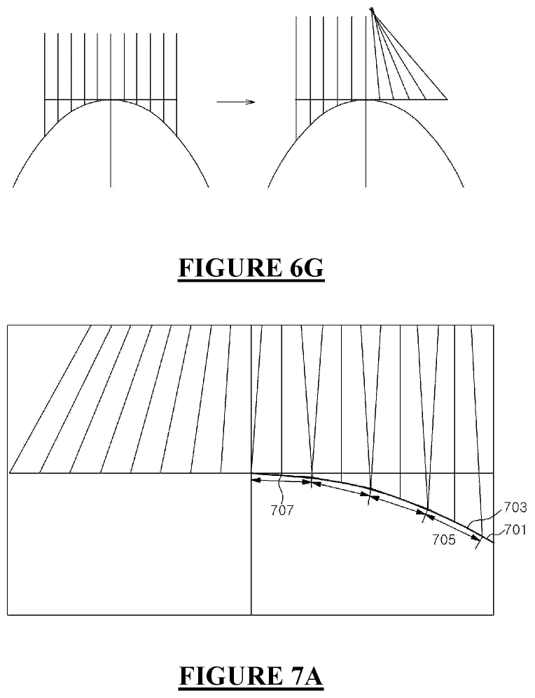

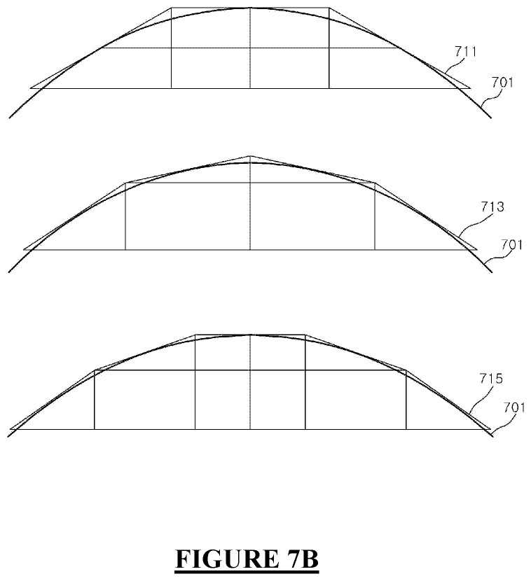

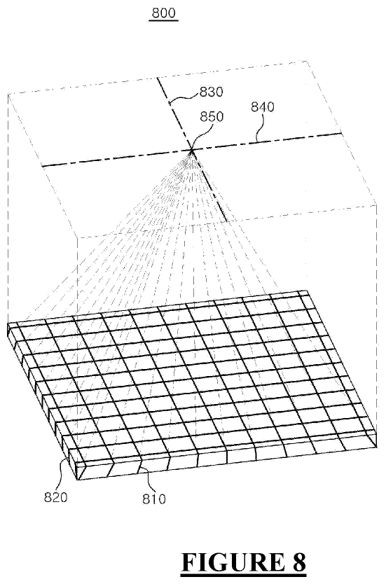

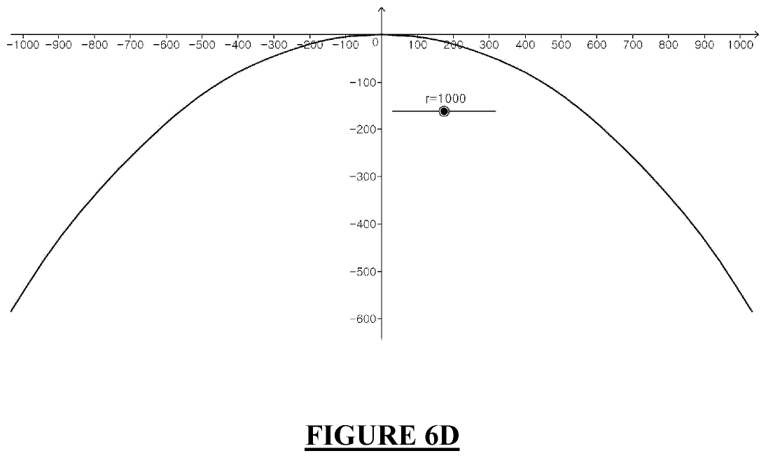

In the present disclosure, the inclined surface 530 has a predetermined calculated shape, as will be described below with reference to FIGS. 6A to 6C. Accordingly, as long as the plurality of blades 521 are parallel to the vertical axis having the center of the inclined surface 530 as the origin, (that is, the plurality of slits 511 formed by the blades 521 are parallel to the vertical axis having the center of the inclined surface 530 as the origin), even when the slit is formed on the abscissa coordinates with the center of the inclined surface 530 as the origin, when the light-transmitting resin layer 510 is placed on a plane, extension lines of the plurality of slits 511 are gathered toward one focal point 540, as illustrated in FIG. 5A.

Therefore, in comparison with the conventional viewing angle-restricting film manufacturing method of alternately stacking a transparent member and an opaque member, heat-compressing the stacked transparent member and opaque member non-uniformly, and then vertically cutting the heat-compressed transparent member and opaque member, according to the method of the present disclosure, it is possible to simultaneously form the plurality of slits toward one focal point with one slit forming part movement on the light-transmitting resin layer, thereby reducing the complexity of the operation.

Referring to FIG. 5B, in contrast to FIG. 5A in which slits 511 are formed in the inclined surface 530 having the convex shape, the slits of the viewing angle-restricting film may be formed by forming slits 551 on an inclined surface 570 having the concave shape.

Referring to FIG. 5B, a slit forming part 560 including a plurality of parallel blades 561 forms the plurality of slits 551 in the light-transmitting resin layer 550. The plurality of parallel blades 561 and the plurality of slits 551 formed by the blades 561 are parallel to the vertical axis having a center of the inclined surface 570 as an origin.

In the present disclosure, the inclined surface 570 has a predetermined calculated shape as will be described below with reference to FIGS. 6A to 6C. Accordingly, as long as the plurality of blades 561 are parallel to the vertical axis having the center of the inclined surface 570 as the origin (that is, the plurality of slits 551 formed by the blades 561 are parallel to the vertical axis having the center of the inclined surface 570 as the origin), even when the slit is formed in the abscissa coordinates with the center of the inclined surface 570 as the origin, when the light-transmitting resin layer 550 is placed on a plane, extension lines of the plurality of slits 551 are gathered toward one focal point 580, as illustrated in FIG. 5B.

FIGS. 6A to 6G illustrate an operation of deriving an inclined surface of a curved shape according to various embodiments of the present disclosure.

Referring to FIG. 6A, a right-angled triangle FOA represents one focal point where the viewing angle-restricting film and the extension lines of the slits meet. One point F in the right-angled triangle FOA corresponds to one focal point of the viewing angle-restricting film. One point O of the right-angled triangle FOA corresponds to a midpoint of the viewing angle-restricting film. One side O̅A̅ of the right-angled triangle FOA corresponds to a right half of the midpoint of the viewing angle-restricting film. Points A1 to Ak to An, which divide the side O̅A̅ of the right-angled triangle FOA into n equal parts, correspond to slits formed at equal intervals on the viewing angle-restricting film. Each of θ₁ to θₖ and θₖ to θₙ is an angle formed between a line connecting each of the points A1 to Ak to An and the point F and O̅F̅ and corresponds to an angle between each slit and one focal point of the viewing angle-restricting film.

A trigonometric function for each of θ₁ to θₖ and θₖ to θₙ may be derived using [Equation 2]

$$\overline{OF} = r \\ \overline{OA} = a \\ Δ X = \overline{{OA}_{k}} - \overline{{OA}_{k - 1}} = \frac{a}{n} \\ {θ}_{k} = ∠ {OA}_{k} F \\ \overline{{OA}_{k}} = \frac{a}{n} k \\ tan {θ}_{k} = \frac{\overline{OF}}{\overline{{OA}_{k}}} = \frac{r n}{a k} \\ cos {θ}_{k} = \frac{a k}{\sqrt{{a}^{2} {k}^{2} + {r}^{2} {n}^{2}}} \\ sin {θ}_{k} = \frac{r n}{\sqrt{{a}^{2} {k}^{2} + {r}^{2} {n}^{2}}} \qquad [ Equation 2 ]$$

FIG. 6B illustrates that a triangle FAₖ₋₁Aₖ cut in FIG. 6A is connected by rotating about the point Aₖ₋₁ so that a side F̅A̅ₖ̅ is parallel to the y-axis.

For the cut triangle FAₖ₋₁Aₖ, an equation expressing a line made by a base when connected by rotating about the point Aₖ₋₁ so that the side F̅A̅ₖ̅ is parallel to the y-axis can be obtained using [Equation 3].

$${\vec{V}}_{k} = \vec{{A}_{k - 1} A k} = ( \frac{a}{n} sin {θ}_{k} , - \frac{a}{n} cos {θ}_{k} ) \\ {A}^{′} ( X , Y ) = {\sum }_{k = 1}^{n} {\vec{V}}_{k} \\ {X}_{n} = {\sum }_{k = 1}^{n} \frac{a}{n} sin {θ}_{k} = {\sum }_{k = 1}^{n} \frac{a}{n} \frac{r n}{\sqrt{{a}^{2} {k}^{2} + {r}^{2} {n}^{2}}} = {\sum }_{k = 1}^{n} \frac{a r}{\sqrt{{a}^{2} {k}^{2} + {r}^{2} {n}^{2}}} \\ {Y}_{n} = {\sum }_{k = 1}^{n} ( - \frac{a}{n} cos {θ}_{k} ) = - {\sum }_{k = 1}^{n} \frac{a}{n} \frac{a k}{\sqrt{{a}^{2} {k}^{2} + {r}^{2} {n}^{2}}} = {\sum }_{k = 1}^{n} \frac{a}{n} \frac{a k}{\sqrt{{a}^{2} {k}^{2} + {r}^{2} {n}^{2}}} \qquad [ Equation 3 ]$$

With respect to Xₙ and Yₙ of [Equation 3], when

$${lim}_{n \to ∞} \vec{{OA}^{′}} = \vec{{OA}^{″}}$$

and n→∞ are satisfied, X and Y which are coordinates of A″(X,Y), may be represented using [Equation 4] and [Equation 5].

$$\begin{matrix}X = {lim}_{n \to ∞} {X}_{n} = {lim}_{n \to ∞} {\sum }_{k = 1}^{n} \frac{a r}{\sqrt{{a}^{2} {k}^{2} + {r}^{2} {n}^{2}}} = {lim}_{n \to ∞} {\sum }_{k = 1}^{n} \frac{r}{\sqrt{{( \frac{{a}_{k}}{n} )}^{2} + {r}^{2}}} \frac{a}{n} ( Δ t = \frac{a - 0}{n} , {t}_{k} = 0 + \frac{a - 0}{n} k ) = {\int }_{0}^{a} \frac{r}{\sqrt{{t}^{2} + {r}^{2}}} dt = {\int }_{0}^{a} \frac{1}{\sqrt{{( \frac{t}{r} )}^{2} + 1}} dt ( \frac{t}{r} = tan ( u ) , t = r tan ( u ) , dt - r {sec}^{2} u du ) = {\int }_{0}^{{tan}^{- 1} \frac{a}{r}} \frac{1}{\sqrt{{tan}^{2} u + 1}} r \cdot {sec}^{2} udu = {\int }_{0}^{{tan}^{- 1} \frac{a}{r}} \frac{r}{\vert sec u \vert} {sec}^{2} u d u = r {\int }_{0}^{{tan}^{- 1} \frac{a}{r}} sec udu = r {\int }_{0}^{{tan}^{- 1} \frac{a}{r}} \frac{sec u ( sec u + tan u )}{sec u + tan u} d u = r {\int }_{0}^{{tan}^{- 1} \frac{a}{r}} \frac{sec u tan u + {sec}^{2} u}{sec u + tan u} du = {[ r \cdot ln ( sec u + tan u ) ]}_{0}^{{tan}^{- 1} \frac{a}{r}} = r \cdot ln \vert secθ + tan θ \vert = r \cdot ln \vert \frac{\sqrt{( {a}^{2} + {r}^{2} )}}{r} + \frac{a}{r} \vert = r \cdot ln \vert \frac{\sqrt{( {a}^{2} + {r}^{2} )} + a}{r} \vert & [ Equation 4 ] \\ Y = {lim}_{n \to ∞} {Y}_{n} = {lim}_{n \to ∞} {\sum }_{k = 1}^{n} - \frac{a}{n} \frac{a k}{\sqrt{{a}^{2} {k}^{2} + {r}^{2} {n}^{2}}} = - {lim}_{n \to ∞} {\sum }_{k = 1}^{n} \frac{a}{n} \frac{\frac{a}{n} k}{\sqrt{{( \frac{a k}{n} )}^{2} + {r}^{2}}} = - {\int }_{0}^{a} \frac{t}{\sqrt{{t}^{2} + {r}^{2}}} dt = - {\int }_{0}^{a} \frac{\frac{t}{r}}{\sqrt{{( \frac{t}{r} )}^{2} + 1}} dt = - {\int }_{0}^{{tan}^{- 1} \frac{a}{r}} \frac{tan u}{\sqrt{{tan}^{2} u + 1}} r \cdot {sec}^{2} u d u = - {\int }_{0}^{{tan}^{- 1} \frac{a}{r}} r \cdot sec u \cdot tanudu = - r \cdot {[ sec u ]}_{0}^{{tan}^{- 1} \frac{a}{r}} = - r \cdot \{ \frac{\sqrt{( {a}^{2} + {r}^{2} )}}{r} - 1 \} = r - \sqrt{( {a}^{2} + {r}^{2} )} & [ Equation 5 ]\end{matrix}$$

That is, the coordinates X and Y of A″(X,Y) may be expressed using [Equation 6].

$$X = r \cdot ln \frac{\sqrt{( {a}^{2} + {r}^{2} )} + a}{r} \\ Y = r - \sqrt{( {a}^{2} + {r}^{2} )} \qquad [ Equation 6 ]$$

With respect to the coordinates X and Y of A″(X,Y) in [Equation 6], when O̅A̅=a is converted into a parameter t, and then a relational expression of the coordinates X and Y is derived, the following [Equation 7], [Equation 8], and [Equation 9] are obtained.

$$\begin{matrix}\{ \begin{matrix}X = r \cdot ln \frac{\sqrt{( {t}^{2} + {r}^{2} )} + r}{r} \\ Y = r - \sqrt{( {t}^{2} + {r}^{2} )}\end{matrix} \\ \sqrt{( {t}^{2} + {r}^{2} )} = r - y \\ {t}^{2} + {r}^{2} = {r}^{2} - 2 ry + {y}^{2} \\ {t}^{2} = {y}^{2} - 2 ry \\ t = \sqrt{{y}^{2} - 2 ry} \\ X = r \cdot ln \frac{r - y + \sqrt{{y}^{2} - 2 ry}}{r} & [ Equation 7 ] \\ X = r \cdot ln ( \frac{r - y + \sqrt{{y}^{2} - 2 ry}}{r} ) \\ r {e}^{\frac{x}{r}} = r - y + \sqrt{{y}^{2} - 2 ry} \\ ( y - r ) + r {e}^{\frac{x}{r}} = \sqrt{{y}^{2} - 2 ry} \\ {( y - r )}^{2} + 2 ( y - r ) r {e}^{\frac{x}{r}} + {r}^{2} {e}^{\frac{2 x}{r}} = {y}^{2} - 2 ry \\ {r}^{2} + 2 ( y - r ) r {e}^{\frac{x}{r}} + {r}^{2} {e}^{\frac{2 x}{r}} = 0 \\ r ( 1 + {e}^{\frac{2 x}{r}} ) + 2 ( y - r ) {e}^{\frac{x}{r}} = 0 \\ \frac{r ( {e}^{\frac{- x}{r}} + {e}^{\frac{x}{r}} )}{2} + y - r = 0 & [ Equation 8 ] \\ y = r - r \cdot \frac{{e}^{\frac{x}{r}} + {e}^{\frac{- x}{r}}}{2} = \frac{- r}{2} ( {e}^{\frac{x}{r}} - 2 + {e}^{\frac{- x}{r}} ) = \frac{- r}{2} \{ {( {e}^{\frac{x}{2 r}} )}^{2} - 2 ( {e}^{\frac{x}{2 r}} ) ( {e}^{- \frac{x}{2 r}} ) + {( {e}^{\frac{x}{2 r}} )}^{2} \} = \frac{- r}{2} {( {e}^{\frac{x}{2 r}} - {e}^{\frac{- x}{2 r}} )}^{2} = \frac{- r}{2} {( \frac{{e}^{\frac{x}{2 r}} - {e}^{\frac{- x}{2 r}}}{2} )}^{2} = - 2 r \cdot {\{ sinh ( \frac{x}{2 r} ) \}}^{2} = - 2 r \cdot {sinh}^{2} ( \frac{x}{2 r} ) & [ Equation 9 ]\end{matrix}$$

Therefore, the curve underlying the shape of the inclined surface may be expressed as in the following [Equation 10]. [Equation 10] is the same as [Equation 1] described above.

$$y = - 2 r \cdot {sinh}^{2} ( \frac{x}{2 r} ) \qquad [ Equation 10 ]$$

Therefore, the curve underlying the shape of the inclined surface may be expressed as in the following [Equation 10]. [Equation 10] is the same as [Equation 1] described above.

FIG. 6D illustrates a shape when r=1,000 among curves derived according to [Equation 10].

FIG. 6E illustrates that a plurality of lines parallel to the y-axis pass through one common focal point when the plurality of lines parallel to the y-axis are made on the curve of FIG. 6D, and then a line parallel to the y-axis and a piece of the curve are bundled, and the piece of the curve is spread as a straight line.

That is, when the shape of the cross section of the inclined surface is set based on the curve of [Equation 10], a plurality of slits facing a predetermined focal point are formed concurrently on a film formed of the light-transmitting resin layer using a slit forming part including a plurality of parallel blades.

According to an embodiment, the cross section of the inclined surface may have a shape that matches the curve derived according to [Equation 10]. Alternatively, the cross section of the inclined surface may have shapes of some of the curves derived according to [Equation 10].

A circle, ellipse, parabola, and hyperbola have a similar shape having the curve derived according to [Equation 10] and a small difference on the y-axis within a range of ±50% of the distance r based on the origin on the x-axis within a predetermined range on the x-axis from the origin. Therefore, even when the inclined surface of various embodiments of the present disclosure forms the slits based on a curved surface having a shape of a portion of the curve such as a circle, ellipse, parabola and hyperbola within ±50% of the distance r based on the origin on the x-axis, a similar result can be obtained in which the extension lines of the slits are directed toward one focal point or a region around one focal point when the viewing angle-restricting film is disposed on a plane.

Therefore, according to an embodiment, the cross section of the inclined surface may have a curved shape having the curve derived according to [Equation 10] and the difference within the predetermined range on the y-axis and within the predetermined range on the x-axis. According to one embodiment, the cross section of the inclined surface is one of a circle, ellipse, parabola, and hyperbola having the curve derived according to [Equation 10] and a difference within a predetermined range on the y-axis and within a predetermined range on the x-axis. According to an embodiment, the cross section of the inclined surface may have a curved shape having the curve derived according to [Equation 10] and a difference within ±20% of the distance r on the y-axis and within ±50% of the distance r based on the origin on the x-axis. According to one embodiment, the cross section of the inclined surface may have one of a circle, ellipse, parabola, and hyperbola having the curve derived according to [Equation 10] and the difference within the predetermined range on the y-axis and within the predetermined range on the x-axis.

FIGS. 6F and 6G illustrate that lines parallel to the y-axis are made at points on a circle and a parabola and the lines are cut so that cut surfaces of the circle or parabola are rotated to be parallel to the x-axis and connected to each other.

Referring to FIGS. 6F and 6G, when arranging a piece of a curve on a straight line by combining lines perpendicular to the tangent line of the highest point of the curve using some sections of the curve of a circle and a parabola, it can be seen that lines perpendicular to the tangent line of the highest point of the circle and parabola are rotated and then directed toward one region.

Therefore, in a case where the curve having the curve derived according to [Equation 10] and the difference within ±20% of the distance r on the y-axis and within ±50% of the distance r based on the origin on the x-axis is used, even when any curve other than the curve derived according to [Equation 10] is used, a viewing angle-restricting effect similar to the embodiments using [Equation 10] can be obtained.

In front of the computer monitor, a user is not always positioned at one focal point of the viewing angle-restricting film to work, and the user may move his/her head and waist. In this case, due to the movement of the head or waist, the field of view may be moved in a front-rear or lateral direction by 45° or more, and thus, the user may move about ±20 cm in a front-rear or lateral direction. Therefore, when the focal point is 100 cm, a visible range may be flexible in a ±20% range, which is ±20 cm from the focal point so that the user can perform the work in a comfortable posture without rigidity.

FIGS. 7A and 7B illustrate an operation of deriving an inclined surface in a polygonal shape according to various embodiments of the present disclosure.

FIG. 7A illustrates an operation of deriving a polygonal inclined surface by connecting tangent lines having the same length with respect to a curve derived according to Equation 10.

Referring to FIG. 7A, the tangent lines 703 of the curve 701 derived according to Equation 10 are connected to have the same length to form a polygon.

According to an embodiment, the inclined surface may have a polygonal shape including a predetermined number of tangent lines 703 for the curve 701 derived according to [Equation 10]. Lengths of sides of the polygon may be equal to each other (as shown by reference number 705).

When the inclined surface is in the form of a polygon including a predetermined number of tangent lines 703 for the curve 701 derived according to [Equation 10], the extension lines of the slits of the viewing angle-restricting film have the same angle for each zone. Each of the angles of the extension lines for each zone is an angle between a contact point 707 and the X-axis in each tangent line 703. When the sides of the polygon have the same length 705, the contact point 707 at each tangent line 703 is a midpoint of each side. Accordingly, in this case, each of the angles of the extension lines for each zone is the angle between the midpoint 707 of each zone and the X-axis.

FIG. 7B illustrates, by way of example, an inclined surface 711 having three faces, an inclined surface 713 having four faces, and an inclined surface 715 having five faces. In each of the polygonal inclined surfaces 711, 713, and 715, the sides thereof have the same length.

FIG. 8 illustrates a viewing angle-restricting film in which first slits and second slits are formed according to various embodiments of the present disclosure.

Referring to FIG. 8, in a viewing angle-restricting film 800, a plurality of second slits 820 are formed in a direction perpendicular to the plurality of first slits 810. Extension lines of the plurality of first slits 810 pass through a virtual vertical line 830. Extension lines of the plurality of second slits 820 pass through a virtual horizontal line 840. The virtual vertical line 830 and the virtual horizontal line 840 meet each other at a virtual intersection 850. Since each of the virtual lines 830 and 840 correspond to a region through which light passes, a maximum amount of light may pass through the virtual intersection 850. Therefore, since the viewing angle-restricting film 800 can be set to be most visible from positions of the user's eyes through the virtual intersection 850, security of the viewing angle-restricting film 800 used as a security film can be strengthened.

When only a portion of the viewing angle-restricting film 800 according to various embodiments of the present disclosure is selectively used and used for a digital number-type door lock or the like, a principle of restricting the viewing angle may be used even for objects that are not positioned perpendicular to the front of the user. Therefore, when the inclined surface according to various embodiments of the present disclosure using [Equation 10] is formed, the inclined surface may not be symmetrical.

According to various embodiments of the present disclosure, with respect to the light-transmitting resin layer, after a plurality of first slits are formed in the first inclined surface, a plurality of second slits may be formed in a plurality of second inclined surfaces having an inclination direction different from that of the first inclined surface. The inclination direction of each first inclined surface and the inclination direction of each second inclined surface may be perpendicular to each other. When the light-transmitting resin layer is disposed on a plane, the extension lines of the plurality of first slits and the extension lines of the plurality of second slits may pass through one common focal point.

The embodiments described above are those in which components and features of the present disclosure are combined in a predetermined form. Each component or feature should be considered optional unless explicitly stated otherwise. Each component or feature may be implemented in a form that is not combined with other components or features. Moreover, it is also possible to combine some components and/or features to form an embodiment of the present disclosure. The order of operations described in embodiments of the disclosure may be changed. Some configurations or features of an embodiment may be included in other embodiments or may be replaced with corresponding configurations or features of other embodiments. It is obvious that claims that are not explicitly cited in the claims can be combined to form an embodiment or included as a new claim by amendment after filing.

It will be apparent to those skilled in the art to which the present disclosure pertains that the present disclosure may be embodied in other forms without departing from a technical spirit and essential characteristics of the present disclosure. Accordingly, the above embodiments should be considered in all respects as illustrative and not restrictive. A scope of the present disclosure should be determined by a reasonable interpretation of the appended claims and all possible changes within the equivalent scope of the present disclosure.

What is claimed is:

1. A method for manufacturing a viewing angle-restricting film, the method comprising:
arranging a light-transmitting resin layer on a first inclined surface, wherein the light-transmitting layer is one of a liquid light-transmitting resin layer and a solid light-transmitting resin layer;
forming a plurality of parallel first slits in the light-transmitting resin layer using one of a plurality of blades arranged parallel to each other and a plurality of lasers arranged parallel to each other; and
filling the plurality of first slits with a light non-transmitting material to form a viewing angle-restricting film including the light-transmitting resin layer and the light non-transmitting material,
wherein the first inclined surface has a curved shape, a depth direction of each of the plurality of first slits is perpendicular to a tangent line of a highest point of the first inclined surface, and a length direction of each of the plurality of first slits is perpendicular to the first inclined surface, and
when the viewing angle-restricting film is disposed on a plane, extension lines of the plurality of first slits are directed toward one common region, and the one common region is one region within a predetermined range around one common focal point.

2. The method of claim 1, wherein a cross section of the first inclined surface has a curved shape according to an equation, wherein the equation is:
$$y = - 2 r \cdot {sinh}^{2} ( \frac{x}{2 r} )$$
and wherein x denotes a coordinate on a horizontal axis with a center of the first inclined surface as an origin, y denotes a coordinate on a vertical axis with the center of the first inclined surface as the origin, and r denotes a distance from the center of the first inclined surface to the one common region.

3. The method of claim 1, wherein a cross section of the first inclined surface has a curved shape according to an equation and a difference within ±20% of r on a y-axis and a difference within ±50% of r based on an origin on an x-axis, wherein the equation is:
$$y = - 2 r \cdot {sinh}^{2} ( \frac{x}{2 r} )$$
and wherein x denotes a coordinate on a horizontal axis with a center of the first inclined surface as an origin, y denotes a coordinate on a vertical axis with the center of the first inclined surface as the origin, and r is a distance from the center of the first inclined surface to the one common region.

4. The method of claim 1, wherein a cross section of the first inclined surface is a polygon including a predetermined number of tangent lines for a curve according to an equation, wherein the equation is:
$$y = - 2 r \cdot {sinh}^{2} ( \frac{x}{2 r} )$$
and wherein x denotes a coordinate on a horizontal axis with a center of the first inclined surface as an origin, y denotes a coordinate on a vertical axis with the center of the first inclined surface as the origin, and r denotes a distance from the center of the first inclined surface to the one common region.

5. The method of claim 4, wherein lengths of sides of the polygon are the same.

6. The method of claim 1, further comprising:
arranging the light-transmitting resin layer on a second inclined surface having a second inclination direction that is different than a first inclination direction of the first inclined surface; and
forming a plurality of parallel second slits in the light-transmitting resin layer,
wherein a depth direction of each of the plurality of second slits is perpendicular to a tangent line of a highest point of the second inclined surface, and a length direction of each of the plurality of second slits is perpendicular to the inclination of the second inclined surface.

7. The method of claim 6, wherein, when the viewing angle-restricting film is disposed on the plane, the extension lines of the plurality of first slits and extension lines of the plurality of second slits are directed toward the one common region.

8. The method of claim 6, wherein the first inclination direction and the second inclination direction are perpendicular to each other.

9. The method of claim 6, further comprising filling the plurality of first slits and the plurality of second slits with the light non-transmitting material.

10. An apparatus for manufacturing a viewing angle-restricting film, the apparatus comprising:
a first inclined surface on which a light-transmitting resin layer is disposed, wherein the light-transmitting layer is one of a liquid light-transmitting resin layer or a solid light-transmitting resin;
a first slit forming part in which a plurality of parallel first slits are formed in the light-transmitting resin layer using one of a plurality of blades arranged parallel to each other and a plurality of lasers arranged parallel to each other; and
an injection unit through which the plurality of first slits is filled with a light non-transmitting material to form a viewing angle-restricting film including the light-transmitting resin layer and the light non-transmitting material,
wherein the first inclined surface has a curved shape, a depth direction of each of the plurality of first slits is perpendicular to a tangent line of a highest point of the first inclined surface, and a length direction of each of the plurality of first slits is perpendicular to the first inclined surface, and
when the viewing angle-restricting film is disposed on a plane, extension lines of the plurality of first slits are directed toward one common region, and the one common region is one region within a predetermined range around one common focal point.

11. A viewing angle-restricting film manufactured according to claim 1.
